(19) United States
(12) Patent Application Publication
(10) Pub. No.: US 2009/0248295 A1
(43) Pub. Date: Oct. 1, 2009

(54) Terrain overlay for route planner

(75) Inventor: Anthony J. Grewe, Fogelsville, PA (US)

Correspondence Address: IP Legal Services, 1500 East Lancaster Avenue, Suite 200, P.O. Box 1027, Paoli, PA, 19301, US

(73) Assignee: AGERE SYSTEMS INC.

(21) Appl. No.: 12/079,385

(22) Filed: Mar. 26, 2008

(51) Int. Cl. G01C 21/34; G01S 5/00

(52) U.S. Cl. 701/202

(57) ABSTRACT

In described embodiments, closed-loop mapping employs terrain and topology information when generating a closed-loop route given input route characteristics. Terrain and topology information collectively identify, for example, whether the road is 1) flat or inclined; 2) paved, concrete, crushed stone, or dirt; 3) in open or shaded areas, and 4) within certain area types. The location of the start and end points (e.g., a geographic location or position), the length of the desired route, and route characteristics are received as input to generate the closed-loop route. Route characteristics might include, for example, i) particular inclines/declines to modify the cardiovascular exercise from traversing the output closed route, ii) preferred types of terrain the output closed route includes, such as pavement or dirt paths, and iii) particular zones or areas to be included or avoided in the desired route.

### BACKGROUND OF THE INVENTION

1. Field of the Invention

The present invention relates to route generation, and, in particular, to incorporation of terrain factors in route planning systems.

2. Description of the Related Art

Computer generated maps are known and in relatively wide use. For example, many GPS (Global Positioning System) products employ computer-generated maps that are used in conjunction with user location information determined through the GPS system to plan trip routes and directions for user travel. Web-based map sites, such as Google, MapQuest, and Yahoo, also offer customized, point-to-point directions from any starting address to any destination address (termed herein “point-to-point mapping systems”).

For activities such as hiking, bicycling, and running, a user's desired route might have a desired length and might start and end in the same location. In these cases, computer-generated maps and routed by point-to-point mapping systems are not well-suited for turn-by-turn directions in closed loops, since these point-to-point mapping systems generally are optimized to provide the shortest route between two points. Recently, methods have been developed to generate closed-loop maps in various formats: static maps, turn-by-turn listings, or interactive maps (termed herein “closed-loop mapping systems”).

For example, U.S. Pat. No. 7,162,363 to Chinitz filed on Dec. 22, 2004, describes a travel route mapping method and system for providing a closed route for travel. The travel route mapping method and system features a database having geographic information and input information including a starting point and a desired route length. The geographic information from the database and the input information are processed to define an outbound path from the starting point to a turning point, the turning point determined based on the desired route length, and to define an inbound path from the turning point to the starting point, the outbound path and the inbound path together defining the closed route.

Unfortunately, such closed loop mapping systems, while providing routes that account for road length and size, do not account for terrain or topology information. Terrain and topology information collectively identify, for example, whether the road is 1) flat or inclined; 2) paved, concrete, stone, or dirt; 3) in open or shaded areas, and 4) within certain area types.

### SUMMARY OF THE INVENTION

In one embodiment, the present invention generates a closed route for travel by receiving input data including a start point, an end point, a desired route length, and route characteristics; and retrieving geographic information for a plurality of route segments from a storage location, wherein the geographic information includes geographic data and terrain and topology information for each of the plurality of route segments. The geographic information and input data are processed to define i) an outbound path from the start point to a turning point, and ii) an inbound path from the turning point to the end point, wherein processing the geographic data includes selecting one or more route segments from the geographic data for the outbound path based on the input data, and selecting one or more route segments for the inbound path based on the input data. The outbound path and the inbound path are combined into the closed route.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an exemplary flowchart for a method employed by a closed loop mapping system in accordance with an exemplary embodiment of the present invention.

FIG. 2A shows terrain and topology information for an area from a topographic map;

FIG. 2B shows terrain and topology information for an area from a geological map;

FIG. 2C shows terrain and topology information for an area from a digital orthophoto quadrangle map,

FIG. 2D shows terrain and topology information for an area from a contour lines map;

FIG. 2E shows terrain and topology information for an area from a digital elevation map; and

FIG. 3 shows an exemplary embodiment of a closed-loop mapping system employing an exemplary embodiment of the present invention.

### DETAILED DESCRIPTION

In accordance with exemplary embodiments of the present invention, a closed-loop mapping system employs terrain and topology information when generating a closed route given input desired route characteristics. Terrain and topology information collectively identify, for example, whether the road is 1) flat or inclined; 2) paved, concrete, crushed stone, or dirt; 3) in open or shaded areas, and 4) within certain area types. While the exemplary embodiments described herein refer to a closed-loop mapping system having the same geographic start and end point, the present invention is not so limited, and might be extended to other mapping systems that employ methods that do not necessarily start and end at the same point, but rather at predefined geographic start and end points that may be defined by a user's input data to the mapping system algorithm.

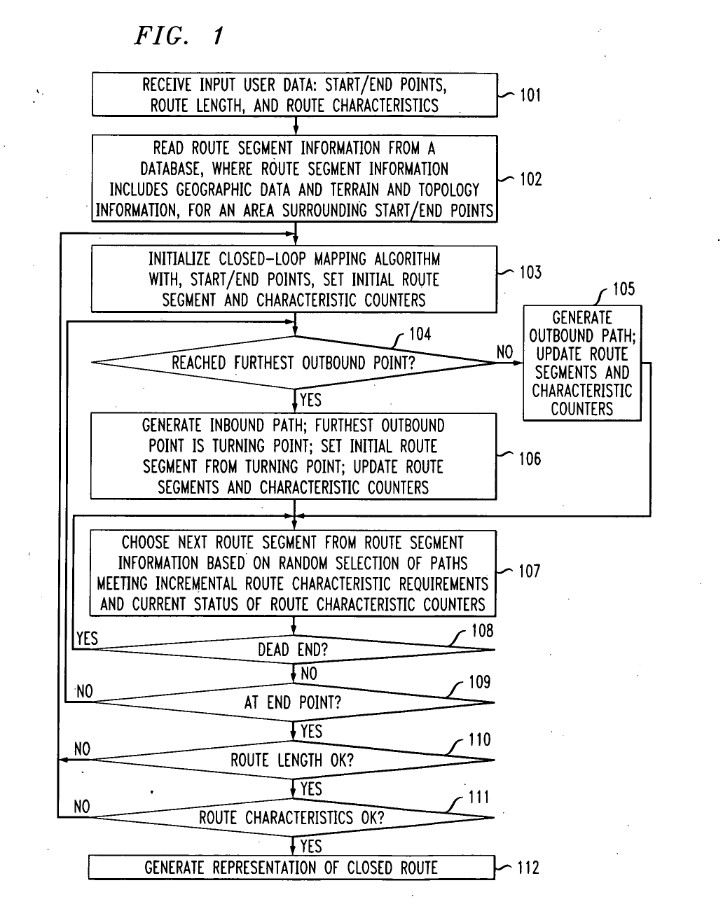

FIG. 1 shows an exemplary flowchart for a method employed by a closed loop mapping system in accordance with an exemplary embodiment of the present invention. At step 101, the method receives as input data the location of the start and end points (e.g., a geographic location or position), the length of the desired route, and route characteristics. Route characteristics might include, for example, particular inclines/declines to modify, for example, the cardiovascular exercise from traversing the output closed route of the method. In addition, the user might input preferred types of terrain and topology the output closed route includes, such as pavement or dirt paths, and particular zones or areas to be included or avoided in the desired closed route.

The method of FIG. 1 might employ any of a number of closed loop mapping algorithms known in the art. For example, U.S. Pat. No. 7,162,363 to Chinitz filed on Dec. 22, 2004, incorporated herein in its entirety by reference, describes a travel route mapping method and system for providing a closed route for travel (hereinafter “Chinitz”). Such algorithms employ road segment information typically retrieved from memory or a database of road information. In one embodiment this can be the TIGER/Line files (Topologically Integrated Geographic Encoding and Referencing system) from the United States Census Bureau, but the method is general enough to work with any suitable database of road information, such as that from web-based map sites, such as Google, MapQuest, and Yahoo. At step 102, the method reads geographic information for the route (e.g., road) segment information from a database or memory, wherein route segment information includes geographic data and terrain and topology information for an area surrounding the received input start/end points.

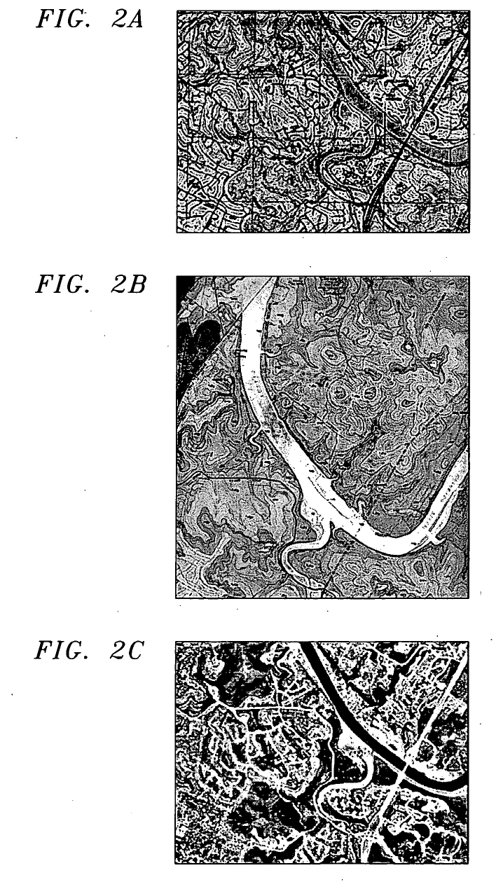

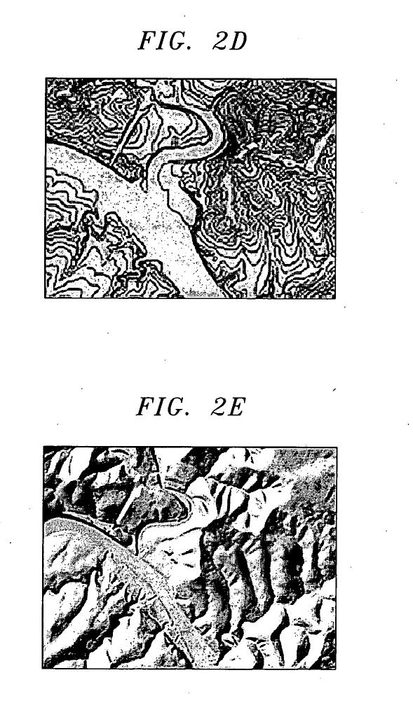

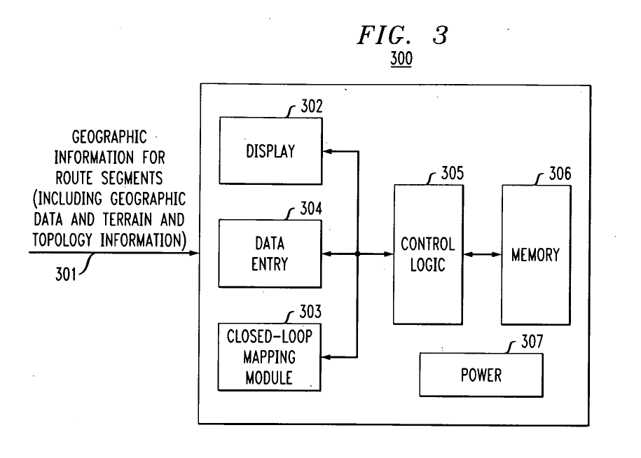

FIG. 2A shows terrain and topology information for an area from a topographic map, FIG. 2B shows terrain and topology information for the area from a geological map, and FIG. 2C shows terrain and topology information for the area from a digital orthophoto quadrangle map. FIG. 2D shows terrain and topology information for the area from a contour lines map; and FIG. 2E shows terrain and topology information for the area from a digital elevation map.

FIGS. 2A through 2E are exemplary maps and graphics from the U.S. Department of the Interior—U.S. Geological Survey. Information from such maps and graphics from the U.S. Department of the Interior is available through web-based mapping tools, such as provided by Google, and might be processed by the method described herein to derive terrain and topology information on a road segment by road segment basis for a given map area. Such processing might include overlaying the spatial information from one source on existing map data from another source to derive conclusions for road segments. Alternatively, all the terrain and topology information may be retrieved from a single source.

At step 103, the method initializes the closed loop mapping algorithm so as to begin calculation of the closed-loop route. Such initialization selects an initial route segment for the outbound path and initializes counters or other record-keeping locations for each of the desired route characteristics input by the user. In addition, the method might arbitrarily set a furthest outbound point for the algorithm's use to reach before beginning to select route segments for an inbound path to the end point. Such outbound point might be based on, for example, dividing the length (e.g., distance) of the desired route in half, but other methods might be employed to select the furthest outbound point as described subsequently.

At step 104, a test determines whether the method generated a tentative closed route portion that has reached the furthest outbound point. If the test of step 104 determines that the route that has been created up until this point has not reached the furthest outbound point, the algorithm continues to generate the outbound path at step 105. At step 105, the route segments in the path and the route characteristic counters are updated. If the test of step 104 determines that the route that has been created up until this point has reached the furthest outbound point, the algorithm sets the furthest point as the turning point and generates the inbound path at step 106. At step 106, the route segments in the path and the route characteristic counters are updated.

For example, if the basic operation shown in FIG. 1 employs the teachings of Chinitz, the user, at step 101, may enter 20 miles for the desired route length. While creating the route, the method continues to select new paths until an outbound point is reached such that the sum of the length to this point, plus the straight line distance back to the starting point is equal to 20 miles. Once the method has reached a point at the furthest outbound distance, it will then choose paths that head back towards the starting point. If the teachings of Chinitz are used, the test of step 104 might employ a furthest outbound point defined to be the point at which, if the route were to include the distance between its current location and the starting location, the total route length (the sum of the length up until the furthest outbound point, and the straight line distance between that point and the starting location) would equal the length of the desired route.

The process of choosing these paths, either in the outbound direction from the start point (e.g., step 105) or toward the end point in the inbound (return) direction, (e.g., step 106) has a finite number of options available to the method when it is on any given road segment (see FIG. 1). So, at step 107, the method determines the options at the current position of the path.

In the basic mode of operation depicted here, the method selects among the possible options for a road segment at random based on available paths (road segment sets) meeting incremental route characteristic requirements and current status of the road characteristic counters. For example, the available paths might be compared based on elevation of the route segment, type of road segment surface (e.g., paved), and area that the route segment is in. Other embodiments of the method might differ primarily in the manner of selecting among these options, and many other techniques for selecting such options are known in the art. Once an option is chosen, the method checks to see if there are any possibilities to continue the route; therefore, at step 108, a test determines whether the method has met a dead end. As employed herein, the term “dead end” generally refers to a condition where, when selecting a new road segment at a point in the outbound path or the inbound path, there is no further advance without re-traversing the prior-selected road-segment of the path. More sophisticated methods might allow for some road segments to be re-traversed, but specify a minimum distance covered before such re-traversing of the prior-selected road segment(s) occurs. If the test of step 108 meets a dead end, the method returns to step 107. Since a dead end is not an optimal solution, the method rejects this option and backs up to the previous route segment. This loop of operations (select an option, check to see that it is not a dead end and, if it is, back up) continues until an acceptable next option for a route segment is found.

Note that step 107 operates differently before and after reaching the furthest outbound point on the tentative closed route portion (i.e., from step 105 or step 106). When selecting a route segment, on the outbound path a preference is to head away from the start point, while, on the inbound path, a preference is to head back to the end point to cause the route to close. These preferences might be operated in conjunction with the choice of random route segment.

Although the specifics of this technique might vary among implementations, in an exemplary implementation these preferences might change as a function of the total route length. For example, when the method begins to head toward the end point (that is, it has reached the furthest outbound point), step 107 might decide that with some low probability (say 10%) it will choose the route segment in the direction of the end point, but with 90% probability it will choose a route segment at random. As the total length of the route increases and gets closer to the desired route length, the method might decide that with very high probability (say 90%) it will choose the route segment in the direction of the ending point. If the total route length exceeds the desired route length, the method might decide to choose the route segment in the direction of the starting location 100% of the time. The goal is to maintain the element of randomness, while still creating a route of the desired length. These percentages are only illustrative; this mechanism of a sliding scale of weighting might be implemented in any number of different ways.

If the test of step 108 does not meet a dead end, the method advances to step 109. At step 109, a test determines whether the method has reached the end point. If the test of step 109 determines that the end point is not yet reached, the method returns to step 107. If the test of step 109 determines that the end point is reached, the method advances to step 110.

At step 110, a test determines whether the length of the tentative output closed route is substantially equivalent to the desired route length input by the user. If the test of step 110 determines that the length of the tentative output closed route is not approximately equivalent to the desired route length input by the user, the method returns to step 103 to retry finding the closed route. If the test of step 110 determines that the length of the tentative output closed route is approximately equivalent to the desired route length input by the user, the method advances to step 111. At step 111, a test determines whether the route characteristics of the tentative output closed route meet the requirements of the route characteristics input by the user. If the test of step 111 determines that the route characteristics do not meet the requirements of the route characteristics of input by the user, the method returns to step 103. If the test of step 111 determines that the route characteristics meet the requirements of the route characteristics input by the user, the method advances to step 112.

At step 112, the method generates a representation of the closed route. The representation might be embodied as a static map (e.g., a hardcopy map indicating the closed route), an interactive map (e.g., a visual map on an LCD or plasma screen), and a turn-by-turn listing (e.g., a list of roads and required to turns at each intersection).

FIG. 3 shows an exemplary embodiment of a closed-loop mapping system 300 employing an exemplary embodiment of the present invention, such as that described above with respect to FIG. 1. Closed-loop mapping system 300 might be embodied, for example, as a handheld GPS (Global Positioning System) navigation system, a wireless telecommunication handset, a personal computer, or a personal digital assistant (PDA). Closed-loop mapping system 300 receives input data through interface 301, which interface 301 might be, for example, a USB, IEEE 1394, or similar type of interface. Input data might include road segment information as discussed above. Closed-loop mapping system 300 comprises display 302, data entry module 304, closed-loop mapping module 303, control logic 305 and memory 306. Closed-loop mapping system 300 might also comprise a power module 307 for providing power to various components of the device.

Control logic 305 and memory 306 might be employed by system 300 to provide various control, user interface, and processing functions. For example, memory 306 might contain program code for use by control logic 305, and control logic 305 might control operations for data input/output of display 302 and data entry module 304. Control logic 305 might further control processing by closed-loop mapping module 303. Display 302 might be, for example, an LCD or plasma display for providing instructions to a user and for providing the representation of the closed route, but might also be embodied as a printer or similar device. Data entry module 304 might be, for example, a keypad, touch-screen portion of display 302, or similar device for a user to input data such as the location of the start and end points (e.g., a geographic location or position), the length of the desired route, and route characteristics. Closed-loop mapping module 303 might be a processing module or similar device employed to implement steps of the method described previously with respect to FIG. 1.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

We claim:

1. A method of generating a closed route for travel, the method comprising:
a) receiving input data including a start point, an end point, a desired route length, and route characteristics;
b) retrieving geographic information for a plurality of route segments from a storage location, wherein the geographic information includes geographic data and terrain and topology information for each of the plurality of route segments; and
c) processing the geographic information and input data to define i) an outbound path from the start point to a turning point, and ii) an inbound path from the turning point to the end point, wherein the step of processing the geographic data includes the steps of:
c1) selecting one or more route segments from the geographic data for the outbound path based on the input data, and
c2) selecting one or more route segments for the inbound path based on the input data; and
d) combining the outbound path and the inbound path into the closed route.

2. The invention of claim 1, further comprising the step of providing a representation of the closed route.

3. The invention of claim 2, wherein the representation includes at least one of a static map, an interactive map, and a turn-by-turn listing.

4. The invention of claim 1, wherein the terrain and topology information identifies whether a route segment is 1) flat or inclined; 2) paved, concrete, crushed stone, or dirt; 3) in open or shaded areas, and 4) within certain area types.

5. The invention of claim 1, further comprising the step of obtaining the terrain and topology information for one or more road segments of an area from at least one of a contour lines map, a digital elevation map, a topographic map, a geological map, and a digital orthophoto quadrangle map.

6. The invention of claim 1, wherein the steps of c1) selecting one or more route segments from the geographic data for the outbound path and c2) selecting one or more route segments for the inbound path further comprise the step of updating one or more route characteristic counters for the closed route.

7. The invention of claim 1, wherein the steps of c1) selecting one or more route segments from the geographic data for the outbound path and c2) selecting one or more route segments for the inbound path further comprise the steps of testing for a dead end and, if a dead end is found, repeating the step c1) or c2) to select one or more new route segments.

8. The invention of claim 1, further comprising the step of comparing a route length of the closed route with the desired route length and, if the route length of the closed route is not substantially equivalent to the desired route length, repeating the method until the route length of the closed route is substantially equivalent to the desired route length.

9. The invention of claim 1, wherein the method is embodied as steps in a program executed by the processor of at least one of a handheld GPS (Global Positioning System) navigation system, a wireless telecommunication handset, a personal computer, and a personal digital assistant (PDA).

10. A machine-readable medium, having encoded thereon program code, wherein, when the program code is executed by a machine, the machine implements a method for generating a closed route for travel, comprising the steps of:
a) receiving input data including a start point, an end point, a desired route length, and route characteristics;
b) retrieving geographic information for a plurality of route segments from a storage location, wherein the geographic information includes geographic data and terrain and topology information for each of the plurality of route segments; and
c) processing the geographic information and input data to define i) an outbound path from the start point to a turning point, and ii) an inbound path from the turning point to the end point, wherein the step of processing the geographic data includes the steps of:
c1) selecting one or more route segments from the geographic data for the outbound path based on the input data, and
c2) selecting one or more route segments for the inbound path based on the input data; and
d) combining the outbound path and the inbound path into the closed route.

11. The invention of claim 10, further comprising the step of providing a representation of the closed route.

12. The invention of claim 11, wherein the representation includes at least one of a static map, an interactive map, and a turn-by-turn listing.

13. The invention of claim 10, wherein the terrain and topology information identifies whether a route segment is 1) flat or inclined; 2) paved, concrete, crushed stone, or dirt; 3) in open or shaded areas, and 4) within certain area types.

14. The invention of claim 10, further comprising the step of obtaining the terrain and topology information for one or more road segments of an area from at least one of a contour lines map, a digital elevation map, a topographic map, a geological map, and a digital orthophoto quadrangle map.

15. Apparatus for generating a closed route for travel, the apparatus comprising:
a data entry module configured to receive input data including a start point, an end point, a desired route length, and route characteristics;
control logic configured to retrieve geographic information for a plurality of route segments from a storage location, wherein the geographic information includes geographic data and terrain and topology information for each of the plurality of route segments; and
a closed-loop mapping module configured to process the geographic information and input data to define i) an outbound path from the start point to a turning point, and ii) an inbound path from the turning point to the end point, wherein the closed-loop mapping module processes the geographic data by:
selecting one or more route segments from the geographic data for the outbound path based on the input data,
selecting one or more route segments for the inbound path based on the input data, and
combining the outbound path and the inbound path into the closed route.

16. The invention of claim 15, further comprising a display, and wherein the control logic is further configured to provide a representation of the closed route on the display as at least one of a static map, an interactive map, and a turn-by-turn listing.

17. The invention of claim 15, wherein the terrain and topology information identifies whether a route segment is 1) flat or inclined; 2) paved, concrete, crushed stone, or dirt; 3) in open or shaded areas, and 4) within certain area types.

18. The invention of claim 15, wherein the apparatus obtains the terrain and topology information for one or more road segments of an area from at least one of a contour lines map, a digital elevation map, a topographic map, a geological map, and a digital orthophoto quadrangle map.

19. The invention of claim 15, wherein the apparatus is embodied in at least one of a mobile device and a personal computer.

20. The invention of claim 19, wherein the mobile device is at least one of a handheld GPS (Global Positioning System) navigation system, a wireless telecommunication handset, and a personal digital assistant (PDA).
